(19) United States
(12) Patent Application Publication
(10) Pub. No.: US 2017/0229913 A1
(43) Pub. Date: Aug. 10, 2017

(54) WIRELESS POWER TRANSFER IN WEARABLE DEVICES

(71) Applicant: QUALCOMM Incorporated, San Diego, CA (US)

(72) Inventors: Francesco Carobolante, San Diego, CA (US); Seong Heon Jeong, San Diego, CA (US)

(21) Appl. No.: 15/018,377

(22) Filed: Feb. 8, 2016

(51) Int. Cl. H02J 50/12

(52) U.S. Cl. CPC H02J 50/12

(57) ABSTRACT

Disclosed is an electronic device having a band to secure the electronic device to a user. The electronic device may include a first power receiving element arranged with the band, configured to couple to an externally generated magnetic field to wirelessly receive power. The electronic device may include a second power receiving element arranged along a portion of the band spaced apart from the first power receiving element, configured to couple to the externally generated magnetic field to wirelessly receive power.

### TECHNICAL FIELD

The present disclosure relates generally to wearable electronic devices, and in particular to wireless power transfer in wearable electronic devices.

### BACKGROUND

Wireless power transfer is an increasingly popular capability in portable electronic devices, such as mobile phones, computer tablets, etc. because such devices typically require long battery life and low battery weight. The ability to power an electronic device without the use of wires provides a convenient solution for users of portable electronic devices. Wireless power charging systems, for example, may allow users to charge and/or power electronic devices without physical, electrical connections, thus reducing the number of components required for operation of the electronic devices and simplifying the use of the electronic device.

Wireless power transfer allows manufacturers to develop creative solutions to problems due to having limited power sources in consumer electronic devices. Wireless power transfer may reduce overall cost (for both the user and the manufacturer) because conventional charging hardware such as power adapters and charging chords can be eliminated. There is flexibility in having different sizes and shapes in the components (e.g., magnetic coil, charging plate, etc.) that make up a wireless power transmitter and/or a wireless power receiver in terms of industrial design and support for a wide range of devices, from mobile handheld devices to computer laptops.

Wearable electronic devices having wireless power transfer capability are becoming increasingly common. Providing suitable power receiving capacity in a wearable device is challenging because of the limited space that a wearable device provides.

### SUMMARY

In accordance with some aspects of the present disclosure, an electronic device may include a device body and a band configured to secure the electronic device to a user. The band may be mechanically connected to the device body. A first power receiving element may be disposed at a first location of the band and electrically connected to the electronic circuitry. The first power receiving element may be configured to couple to an externally generated magnetic field to wirelessly receive power. A second power receiving element may be disposed at a second periphery of the band and electrically connected to the electronic circuitry. The second power receiving element may be configured to couple to an externally generated magnetic field to wirelessly receive power.

In some aspects, the first and second locations of the band may be along respective first and second peripheries of the band.

In some aspects, the first power receiving element may couple more strongly to the externally generated magnetic field than does the second power receiving element when the electronic device is in a first orientation relative to the externally generated magnetic field. The second power receiving element may couple more strongly to the externally generated magnetic field than does the first power receiving element when the electronic device is in a second orientation relative to the externally generated magnetic field.

In some aspects, the first and second power receiving elements may have a common electrical connection at a location separate from the device body.

In some aspects, the first power receiving element may comprise a first segment and a second segment. The second power receiving element may comprise a first segment and a second segment. The first segments of the first and second power receiving elements may be connected together at a first node. The second segments of the first and second power receiving elements may be connected together at a second node.

An electrical connection may be provided between the first nodes and the second nodes.

The first and second nodes are electrically connected together when the band is in a closed position, and the first and second nodes may not be electrically connected together when the band is in an open position.

In some aspects, the band may comprise a first band segment having arranged therewith the first segments of the first and second power receiving elements, and a second band segment having arranged therewith the second segments of the first and second power receiving elements. An engagement mechanism may be provided to mechanically engage and disengage the first and second band segments.

In some aspects, the band may be a fold-over kind of band comprising a first band segment having arranged therewith the first segments of the first and second power receiving elements, and a second band segment having arranged therewith the second segments of the first and second power receiving elements, and a folding mechanism.

In some aspects, the first power receiving element may be connected to a first diode rectifier in the electronic circuitry and the second power receiving element may be connected to a second diode rectifier in the electronic circuitry. The first diode rectifier may be active and the second diode rectifier may be inactive when the electronic device is in a first orientation relative to the externally generated magnetic field. The first diode rectifier may be inactive and the second diode rectifier may be active when the electronic device is in a second orientation relative to the externally generated magnetic field. One or more diodes in the first diode rectifier may be reverse biased when inactive. One or more diodes in the second diode rectifier may be reverse biased when inactive.

In some aspects, the electronic device may include a plurality of diodes. The first power receiving element may be electrically connected to a first rectifier comprising a first subset of the plurality of diodes and the second power receiving element may be electrically connected to a second rectifier comprising a second subset of the plurality of diodes when the band is in a closed position. The first power receiving element may be electrically connected to a third rectifier comprising a third subset of the plurality of diodes and the second power receiving element may be electrically connected to a fourth rectifier comprising a fourth subset of the plurality of diodes when the band is in an open position.

In some aspects, the first power receiving element and the second power receiving element may be connected to a single diode rectifier.

In some aspects, the first power receiving element may be connected to a first tuning circuit in the electronic circuitry to define a first resonant circuit, and the second power receiving element may be connected to a second tuning circuit in the electronic circuitry to define a second resonant circuit. The first and second resonant circuits may have respective resonant frequencies substantially equal to the frequency of the externally generated magnetic field. The first and the second tuning circuits may be connected to respective first and second diode rectifiers in the electronic circuitry.

In accordance with some aspects of the present disclosure, a method for an electronic wearable device may include magnetically coupling to an externally generated magnetic field via a first power receiving element (incorporated with a band configured to secure the wearable device to a user) more strongly than via a second power receiving element (also incorporated with the band) when a first edge of the band is closer to the charging unit that produces the externally generated magnetic field than a second edge of the band. The method may include magnetically coupling to the externally generated magnetic field via the second power receiving element more strongly than to the first power receiving element when the second edge of the band is closer to the charging unit than the first edge of the band. The method may include rectifying a first signal produced by the first power receiving element and a second signal produced by the second power receiving element to produce power for the wearable device.

In some aspects, coupling to the externally generated magnetic field via the first or second power receiving element may include completing first and second circuits defined respectively by the first and second power receiving elements and rectifying the first and second signals produced by the first and second power receiving elements using the first and second circuits. Completing the first and second circuits may occur when the band to be in a closed position.

In some aspects, the rectifying includes generating a first rectified signal and a second rectified signal and combining the first and second rectified signals to produce power for the wearable device. The method may further include using a first diode circuit to generate the first rectified signal and using a second diode circuit to generate the second rectified signal.

In some aspects, the rectifying includes combining the first second signals respectively from the first and second power receiving elements and generating a rectified signal from the combined first and second signals.

In some aspects, the method may include operating the first power receiving at a frequency substantially equal to the frequency of the externally generated magnetic field and operating the second power receiving element at a frequency substantially equal to the frequency of the externally generated magnetic field.

In accordance with some aspects of the present disclosure, an electronic device may include means for securing the electronic device to a user of the electronic device, first means for magnetically coupling to an externally generated magnetic field to wirelessly receive power, and second means for magnetically coupling to an externally generated magnetic field to wirelessly receive power.

In some aspects, the electronic device may further comprise means for rectifying signals produced by the first means and by the second means.

In some aspects, the means for rectifying comprises a single diode rectifier circuit.

In some aspects, the means for rectifying comprises a first diode rectifier electrically connected to the first means and a second diode rectifier electrically connected to the second means.

The following detailed description and accompanying drawings provide a better understanding of the nature and advantages of the present disclosure.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. In the accompanying drawings:

FIG. 1 is a functional block diagram of a wireless power transfer system in accordance with an illustrative embodiment.

FIG. 2 is a functional block diagram of a wireless power transfer system in accordance with an illustrative embodiment.

FIG. 3 is a schematic diagram of a portion of transmit circuitry or receive circuitry of FIG. 2 including a power transmitting or receiving element in accordance with an illustrative embodiment.

FIGS. 4, 4A, 4B, and 4C illustrate aspects of a wearable electronic device in accordance with the present disclosure.

FIGS. 5, 5A, 5B, 5C, 5D1, and 5D2 illustrate aspects of circuitry in accordance with the present disclosure.

FIGS. 6A, 6B, and 6C depict wirelessly receiving power in accordance with the present disclosure.

FIG. 7 illustrates another embodiment of circuitry in accordance with the present disclosure.

FIG. 8 illustrates another embodiment of circuitry in accordance with the present disclosure.

FIGS. 9A and 9B illustrate additional aspects of a wearable device in accordance with the present disclosure.

FIGS. 10A and 10B illustrate additional aspects of a wearable device in accordance with the present disclosure.

### DETAILED DESCRIPTION

Drawing elements that are common among the following figures may be identified using the same reference numerals.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured by, or coupled by a “power receiving element” to achieve power transfer.

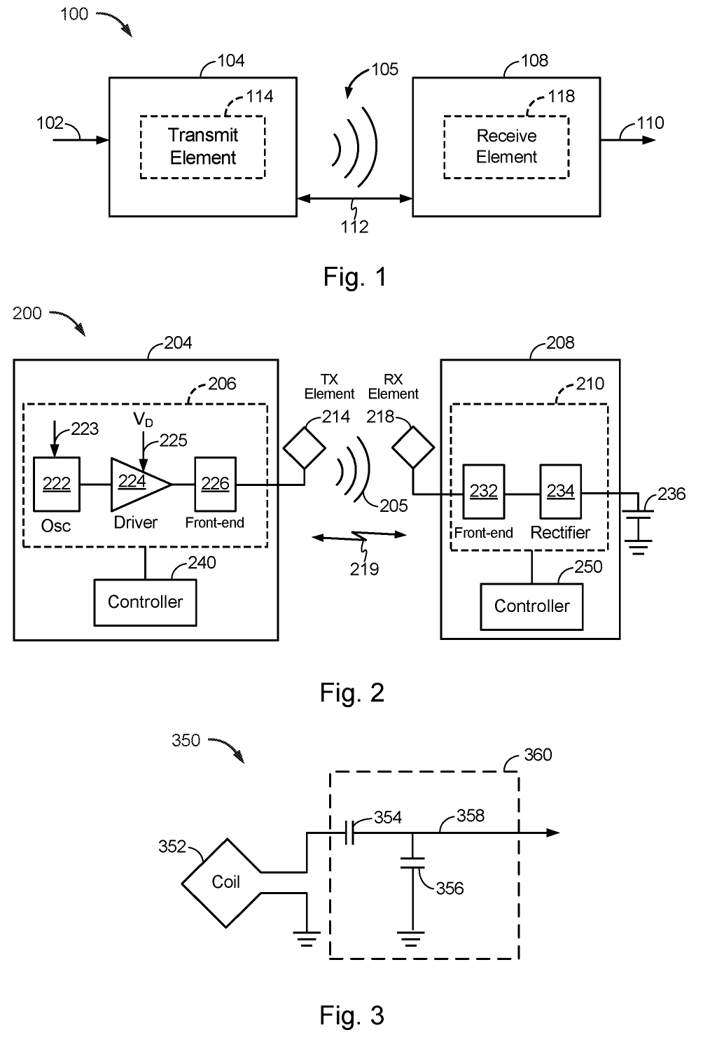

FIG. 1 is a functional block diagram of a wireless power transfer system 100, in accordance with an illustrative embodiment. Input power 102 may be provided to a transmitter 104 from a power source (not shown in this figure) to generate a wireless (e.g., magnetic or electromagnetic) field 105 for performing energy transfer. A receiver 108 may couple to the wireless field 105 and generate output power 110 for storing or consumption by a device (not shown in this figure) coupled to the output power 110. The transmitter 104 and the receiver 108 may be separated by a distance 112. The transmitter 104 may include a power transmitting element 114 for transmitting/coupling energy to the receiver 108. The receiver 108 may include a power receiving element 118 for receiving or capturing/coupling energy transmitted from the transmitter 104.

In one illustrative embodiment, the transmitter 104 and the receiver 108 may be configured according to a mutual resonant relationship. When the resonant frequency of the receiver 108 and the resonant frequency of the transmitter 104 are substantially the same or very close, transmission losses between the transmitter 104 and the receiver 108 are reduced. As such, wireless power transfer may be provided over larger distances. Resonant inductive coupling techniques may thus allow for improved efficiency and power transfer over various distances and with a variety of inductive power transmitting and receiving element configurations.

In certain embodiments, the wireless field 105 may correspond to the “near field” of the transmitter 104. The near-field may correspond to a region in which there are strong reactive fields resulting from the currents and charges in the power transmitting element 114 that minimally radiate power away from the power transmitting element 114. The near-field may correspond to a region that is within about one wavelength (or a fraction thereof) of the power transmitting element 114.

In certain embodiments, efficient energy transfer may occur by coupling a large portion of the energy in the wireless field 105 to the power receiving element 118 rather than propagating most of the energy in an electromagnetic wave to the far field.

In certain implementations, the transmitter 104 may output a time varying magnetic (or electromagnetic) field with a frequency corresponding to the resonant frequency of the power transmitting element 114. When the receiver 108 is within the wireless field 105, the time varying magnetic (or electromagnetic) field may induce a current in the power receiving element 118. As described above, if the power receiving element 118 is configured as a resonant circuit to resonate at the frequency of the power transmitting element 114, energy may be efficiently transferred. An alternating current (AC) signal induced in the power receiving element 118 may be rectified to produce a direct current (DC) signal that may be provided to charge or to power a load.

FIG. 2 is a functional block diagram of a wireless power transfer system 200, in accordance with another illustrative embodiment. The system 200 may include a transmitter 204 and a receiver 208. The transmitter 204 (also referred to herein as power transfer unit, PTU) may include transmit circuitry 206 that may include an oscillator 222, a driver circuit 224, and a front-end circuit 226. The oscillator 222 may be configured to generate an oscillator signal at a desired frequency that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal (VD) 225. The driver circuit 224 may be a switching amplifier configured to receive a square wave from the oscillator 222 and output a sine wave.

The front-end circuit 226 may include a filter circuit configured to filter out harmonics or other unwanted frequencies. The front-end circuit 226 may include a matching circuit configured to match the impedance of the transmitter 204 to the impedance of the power transmitting element 214. As will be explained in more detail below, the front-end circuit 226 may include a tuning circuit to create a resonant circuit with the power transmitting element 214. As a result of driving the power transmitting element 214, the power transmitting element 214 may generate a wireless field 205 to wirelessly output power at a level sufficient for charging a battery 236, or otherwise powering a load.

The transmitter 204 may further include a controller 240 operably coupled to the transmit circuitry 206 and configured to control one or more aspects of the transmit circuitry 206, or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by it. The transmitter 204 may further include a memory (not shown) configured to store data, for example, such as instructions for causing the controller 240 to perform particular functions, such as those related to management of wireless power transfer.

The receiver 208 (also referred to herein as power receiving unit, PRU) may include receive circuitry 210 that may include a front-end circuit 232 and a rectifier circuit 234. The front-end circuit 232 may include matching circuitry configured to match the impedance of the receive circuitry 210 to the impedance of the power receiving element 218. As will be explained below, the front-end circuit 232 may further include a tuning circuit to create a resonant circuit with the power receiving element 218. The rectifier circuit 234 may generate a DC power output from an AC power input to charge the battery 236, as shown in FIG. 2. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. In certain embodiments, the transmitter 204 may be configured to generate a predominantly non-radiative field with a direct field coupling coefficient (k) for providing energy transfer. Receiver 208 may directly couple to the wireless field 205 and may generate an output power for storing or consumption by a battery (or load) 236 coupled to the output or receive circuitry 210.

The receiver 208 may further include a controller 250 configured similarly to the transmit controller 240 as described above for managing one or more aspects of the wireless power receiver 208. The receiver 208 may further include a memory (not shown) configured to store data, for example, such as instructions for causing the controller 250 to perform particular functions, such as those related to management of wireless power transfer.

As discussed above, transmitter 204 and receiver 208 may be separated by a distance and may be configured according to a mutual resonant relationship to minimize transmission losses between the transmitter 204 and the receiver 208.

FIG. 3 is a schematic diagram of a portion of the transmit circuitry 206 or the receive circuitry 210 of FIG. 2, in accordance with illustrative embodiments. As illustrated in FIG. 3, transmit or receive circuitry 350 may include a power transmitting or receiving element 352 and a tuning circuit 360. The power transmitting or receiving element 352 may also be referred to or be configured as an antenna or a “loop” antenna. The term “antenna” generally refers to a component that may wirelessly output or receive energy for coupling to another antenna. The power transmitting or receiving element 352 may also be referred to herein or be configured as a “magnetic” antenna, or an induction coil, a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown in this figure).

When the power transmitting or receiving element 352 is configured as a resonant circuit or resonator with tuning circuit 360, the resonant frequency of the power transmitting or receiving element 352 may be based on the inductance and capacitance. Inductance may be simply the inductance created by a coil and/or other inductor forming the power transmitting or receiving element 352. Capacitance (e.g., a capacitor) may be provided by the tuning circuit 360 to create a resonant structure at a desired resonant frequency. As a non limiting example, the tuning circuit 360 may comprise a capacitor 354 and a capacitor 356, which may be added to the transmit and/or receive circuitry 350 to create a resonant circuit.

The tuning circuit 360 may include other components to form a resonant circuit with the power transmitting or receiving element 352. As another non limiting example, the tuning circuit 360 may include a capacitor (not shown) placed in parallel between the two terminals of the circuitry 350. Still other designs are possible. In some embodiments, the tuning circuit in the front-end circuit 226 may have the same design (e.g., 360) as the tuning circuit in front-end circuit 232. In other embodiments, the front-end circuit 226 may use a tuning circuit design different than in the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352. Although aspects disclosed herein may be generally directed to resonant wireless power transfer, persons of ordinary skill will appreciate that aspects disclosed herein may be used in non-resonant implementations for wireless power transfer.

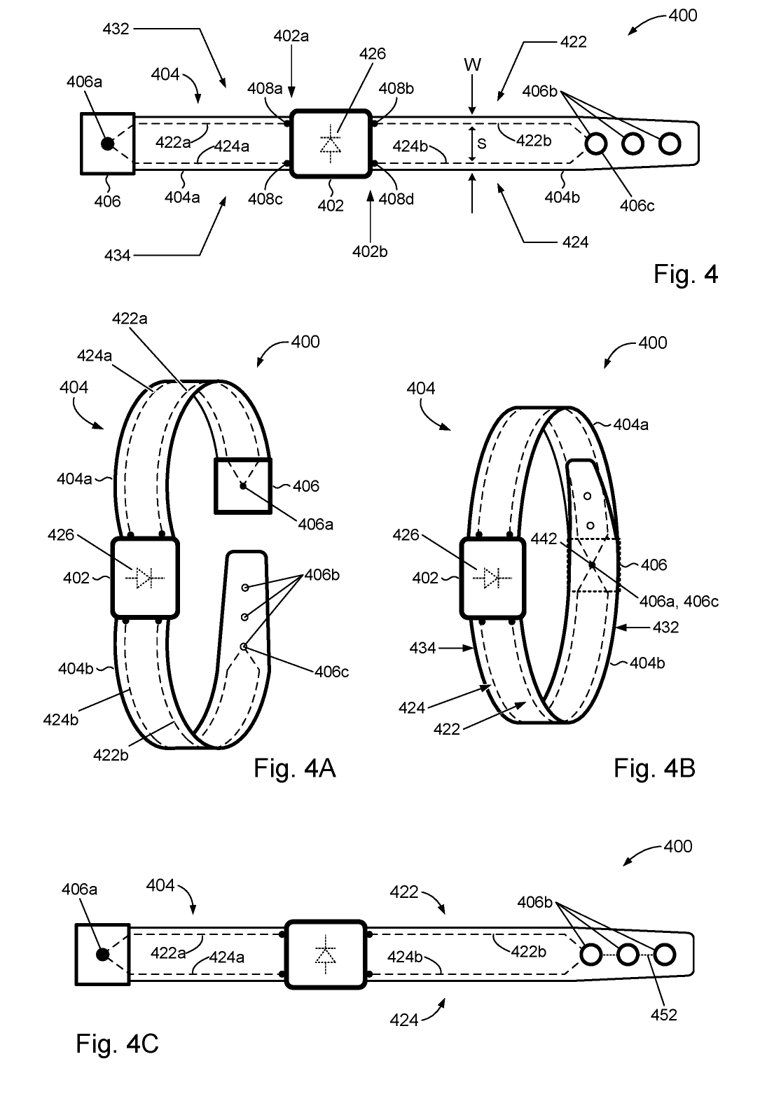

FIGS. 4, 4A, and 4B show aspects of a wearable electronic device 400 configured for wireless power transfer in accordance with the present disclosure. The electronic device 400 may be a digital watch, a wearable computer, a health monitor, or any other electronic equipment that can be worn by a user. The electronic device 400 may include a rechargeable power source (e.g., rechargeable battery, not shown) to provide power to electronic components (not shown) in the electronic device 400.

The electronic device 400 may include a device body 402. In some embodiments, the device body 402 may house various components (not shown) to display information (output) to a user and to receive information (input) from a user, and electronics (not shown) to support the various components. In accordance with the present disclosure, the device body 402 may include circuitry 426 configured to provide wirelessly received power to the various electronics and other electrical components in the device body 402. For example, the circuitry 426 may include one or more of the components described above with respect to the receive circuitry 210 of FIG. 2.

The electronic device 400 may include means for securing the electronic device 400 to a user. In some embodiments, for example, the electronic device 400 may include a band 404; for example, a wristband. The band 404 may include a first band segment 404a and a second band segment 404b. The band 404 may be attached to the device body 402 at a first location 402a and a second location 402b of the device body 402. In some embodiments, the band 404 may include a first band segment 404a and a second band segment 404b. The band segment 404a may be attached to the device body 402 at location 402a of the device body 402. Similarly, the band segment 404b may be attached to the device body 402 at location 402b of the device body 402. Any suitable mechanical attachment may be used; for example, a rigid attachment, a hinged attachment, and so on.

The band 404 may include an engagement mechanism 406. In some embodiments, the engagement mechanism 406 may include a post 406a arranged on one of the band segments 404a. The post 406a may engage with post openings 406b formed on the other of the band segments 404b. The engagement mechanism 406 can mechanically engage and disengage the first and second band segments 404a, 404b. FIG. 4A, for example, shows band 404 in an OPEN position (configuration), where the first and second band segments 404a, 404b are disengaged. FIG. 4B shows band 404 in a CLOSED position, where the first and second band segments 404a, 404b are engaged by the engagement mechanism 406.

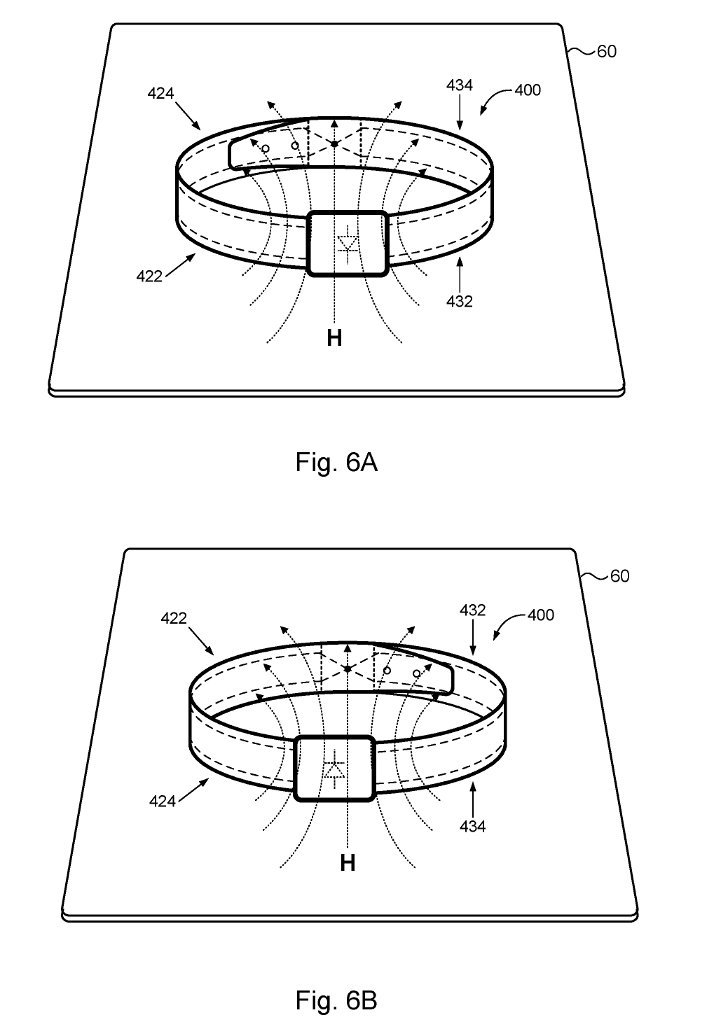

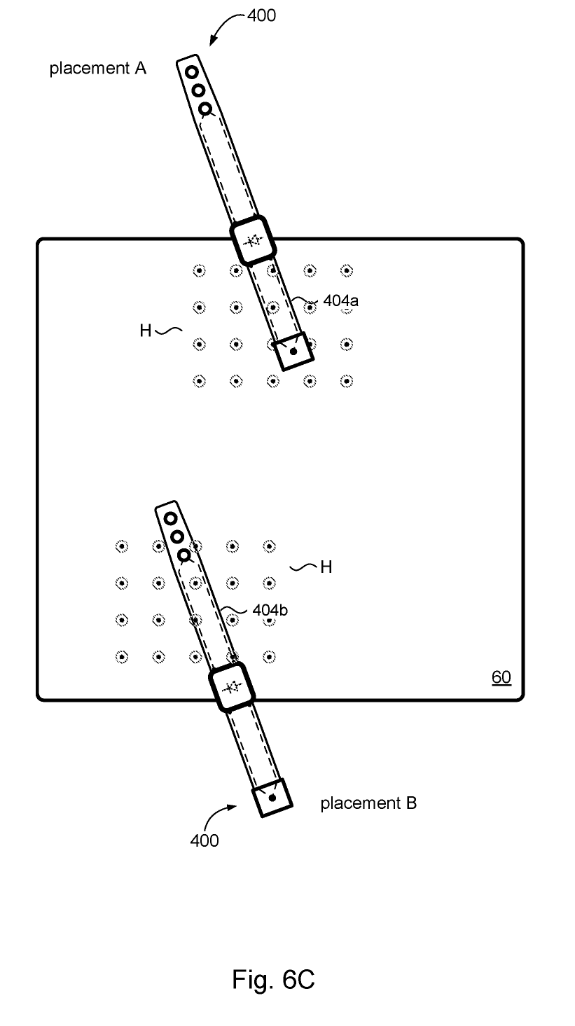

The electronic device 400 may include means for magnetically coupling to an externally generated magnetic field (e.g., magnetic field H in FIG. 6A). In some embodiments, for example, (first) means for magnetically coupling to an externally generated magnetic field may be power receiving element 422, and (second) means for magnetically coupling to an externally generated magnetic field may be power receiving element 424. In some embodiments, the power receiving element 422 may include a first segment 422a and a second segment 422b spaced apart from the first segment 422a. Likewise, the power receiving element 424 may include a first segment 424a and a second segment 424b. In some embodiments, the segments 422a, 422b, 424a, 424b may be formed within the material (e.g., leather, flexible plastic, etc.) used for band 404. In other embodiments, the segments 422a, 422b, 424a, 424b may be arranged on or near the surface of the band 404, or otherwise incorporated with the band 404.

In accordance with the present disclosure, the segments 422a, 422b, 424a, 424b may be located near sides (peripheries) 432, 434 of the band 404. For example, the segments 422a, 422b of power receiving element 422 may be located at side 432 of the band. The segments 424a, 424b of power receiving element 424 may be located at a side 434 of the band 404. For example, if the band 404 has a width W, then the segments 422a, 422b, 424a, 424b being located near respective sides 432, 434 may have a separation S that is approximately W.

The segments 422a, 422b of the first power receiving element 422 may be connected to the circuitry 426 at the first and second locations 402a, 402b of the device body 402. In some embodiments, for example, one end of the first segment 422a of the first power receiving element 422 may connect to circuitry 426 via a terminal 408a at the first location 402a of the device body 402. One end of the second segment 422b of the first power receiving element 422 may connect to circuitry 426 via a terminal 408b at the second location 402b of the device body 402. With respect to the second power receiving element 424, one end of the first segment 424a may connect to circuitry 426 via a terminal 408c at the first location 402a of the device body 402, and one end of the second segment 424b may connect to circuitry 426 via a terminal 408d at the second location 402b of the device body 402.

In some embodiments, ends of the first segments 422a, 424a of respective power receiving elements 422, 424 may have a common connection (node) at post 406a. The post 406a may include an electrically conductive material so that the first segments 422a, 424a are in electrical contact with each other at the post 406a. For example, the post 406a may have an outer coating of electrically conductive material, or may be made from an electrically conductive material. Similarly, ends of the second segments 422b, 424b of respective power receiving elements 422, 424 may have a common connection (node) at one of the post openings 406c. The post opening 406c may include an electrically conductive material so that the second segments 422b, 424b are in electrical contact with each other at the post opening 406c. For example, the post opening 406c may have an outer coating of electrically conductive material, or may be made from an electrically conductive material.

Referring to FIG. 4B, when the band 404 is in the particular CLOSED position shown, the post 406a is engaged with post opening 406c. In this particular CLOSED position, the first and second segments 422a, 422b of power receiving element 422 are connected together at node 442 spaced apart (separate) from the device body 402. The first and second segments 424a, 424b of power receiving element 424 are similarly connected together at node 442 at a location away from the device body 402. As will be explained below, power receiving element 422 completes (defines) a circuit with circuitry 426 when the band 404 is in the particular CLOSED position shown in FIG. 4B. Likewise, power receiving element 424 completes (defines) a circuit with circuitry 426 when the band 404 is in the particular CLOSED position shown in FIG. 4B.

Referring to FIG. 4C, in some embodiments, the post openings 406b may be electrically connected, for example by an electrically conductive connector 452. Each of the post openings 406b may include a coating of electrically conductive material, or may be made from an electrically conductive material. In an embodiment of electronic device 400 that includes connector 452 in the band 404, the power receiving elements 422, 424 may complete a circuit with circuitry when the band 404 is in any CLOSED position; i.e., the post 406a may engage any one of the post openings 406b.

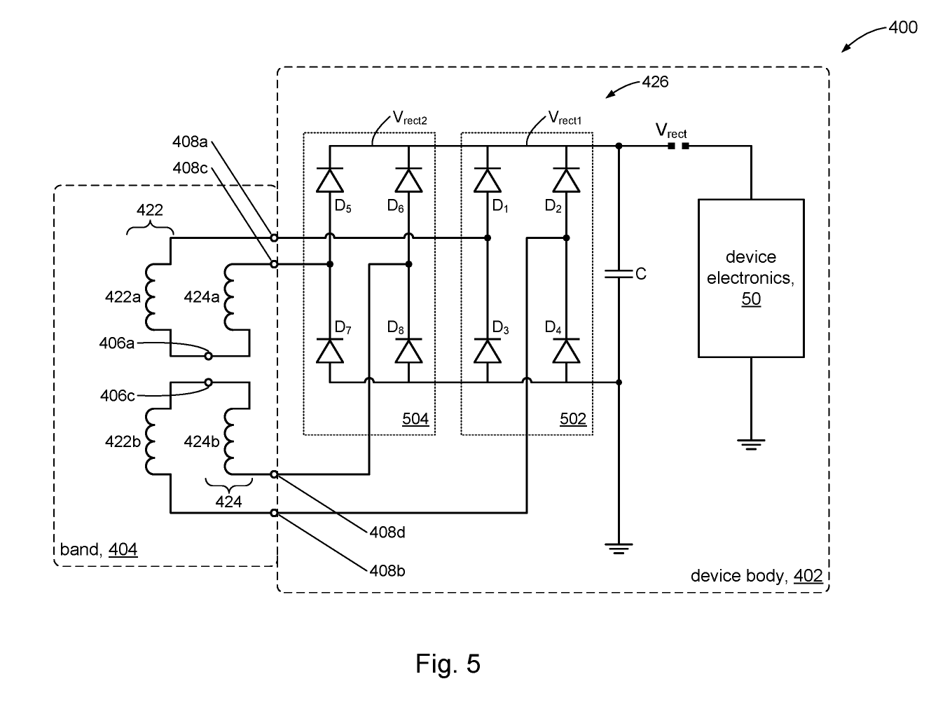

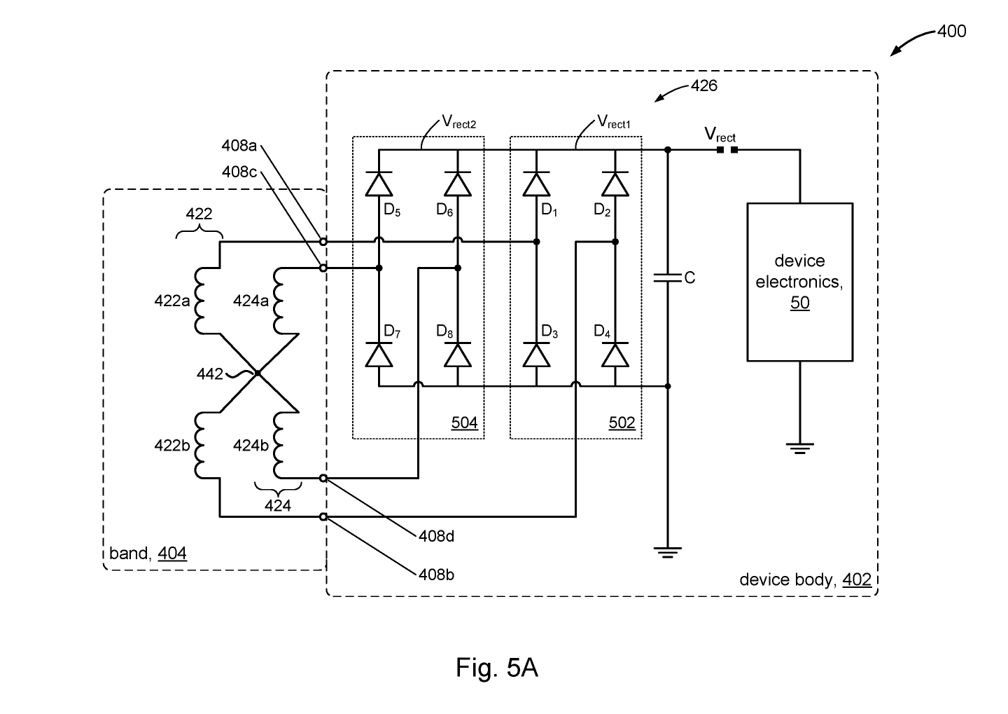

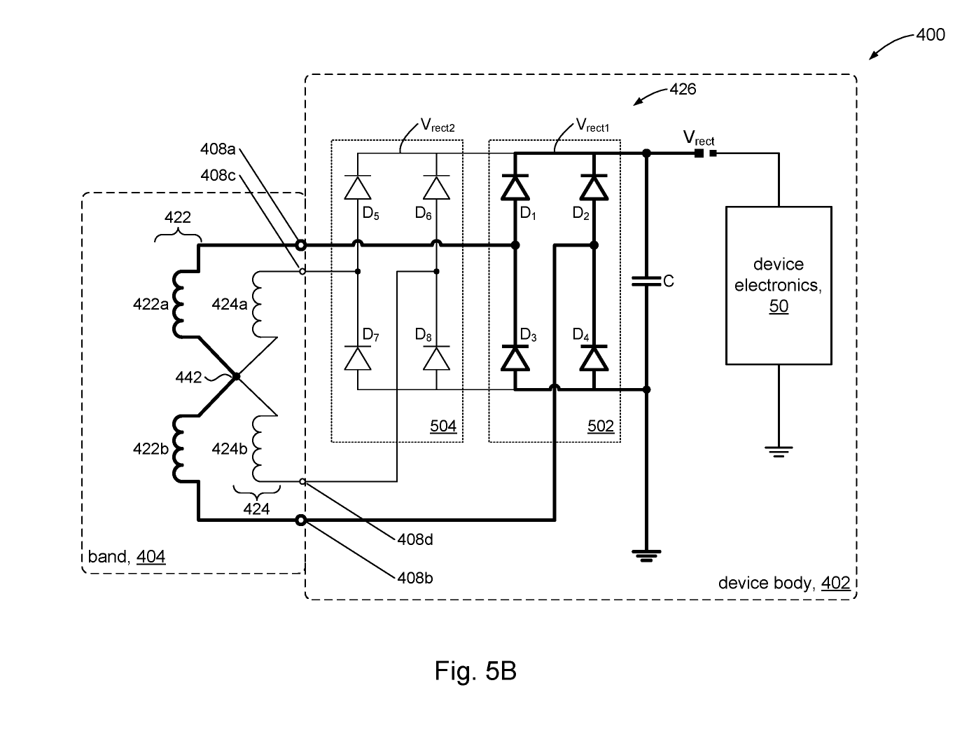

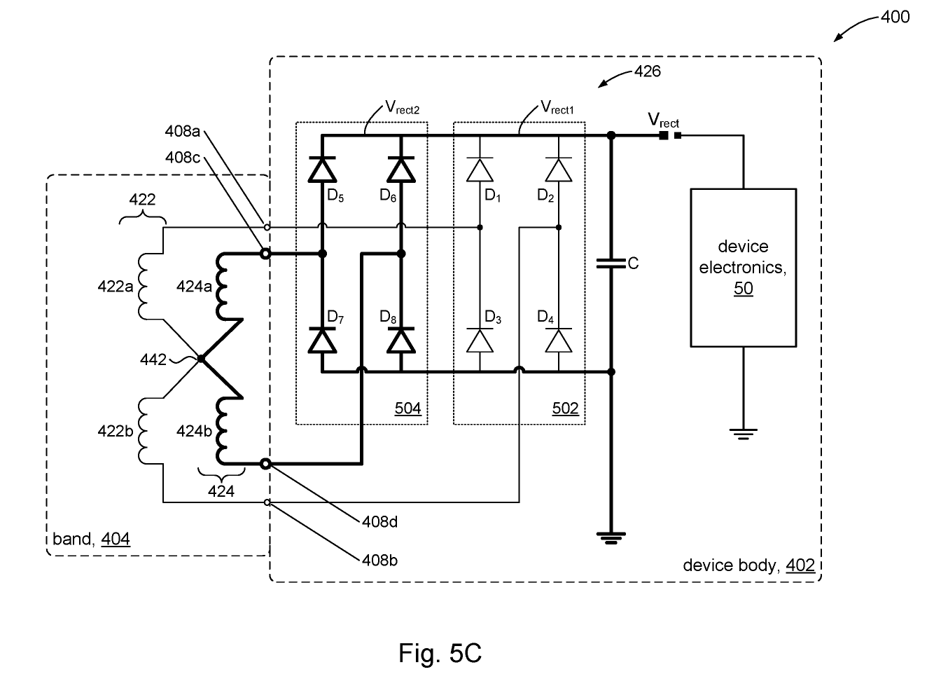

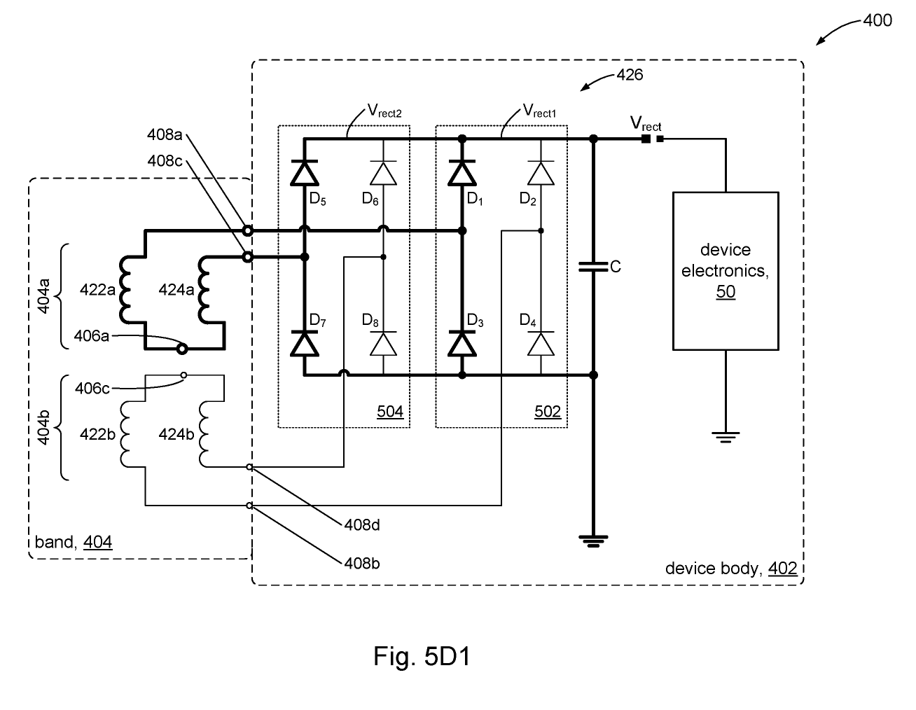

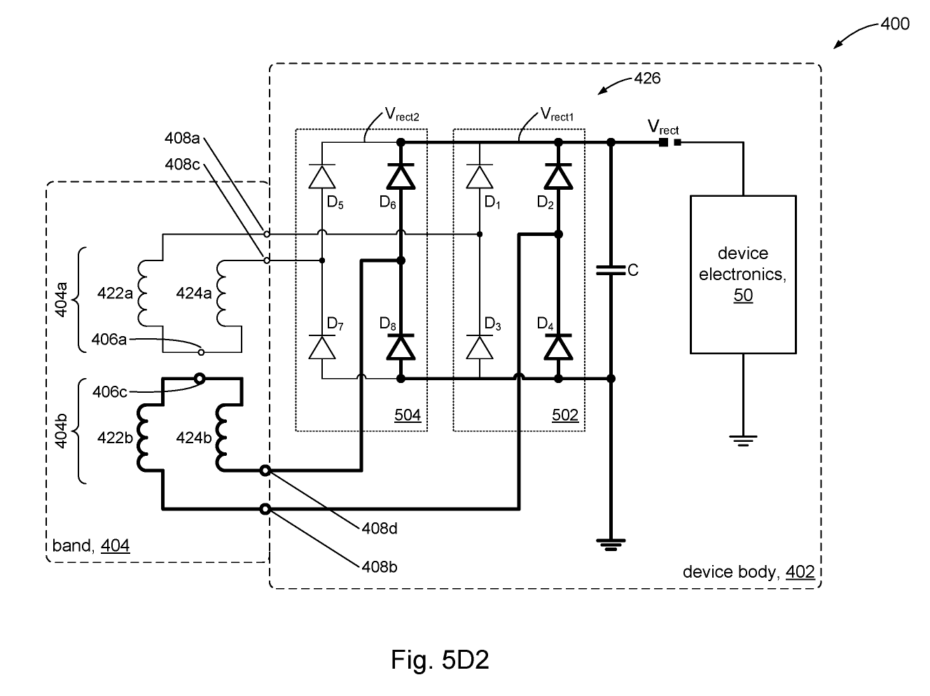

FIG. 5 shows a schematic representation of circuitry 426 in accordance with embodiments of the present disclosure. The segments 422a, 422b of power receiving element 422 and segments 424a, 424b of power receiving element 424 are represented as inductors.

In some embodiments, the circuitry 426 may comprise means for rectifying signals produced by the first and second power receiving elements 422, 424. For example, the circuitry 426 may comprise a first diode rectifier 502 and a second diode rectifier 504. In some embodiments, the first diode rectifier 502 may be full wave rectifier comprising diodes D₁, D₂, D₃, D₄. A capacitor C may be connected across the output V_{rect1} of the first diode rectifier 502. The second diode rectifier 504 may also be a full wave rectifier comprising diodes D₅, D₆, D₇, D₈. The capacitor C may also be connected across the output V_{rect2} of the second diode rectifier 504. The first and second diode rectifiers 502, 504 may be connected in parallel at output V_{rect}. The output V_{rect} may provide power to the device electronics 50 of the electronic device 400. One of ordinary skill will understand that any suitable means for rectifying a signal may be used; e.g., a synchronous FET rectifier, and so on.

The first segment 422a of power receiving element 422 may have a connection to diodes D₁, D₃ of the first diode rectifier 502 and a connection to post 406a. The second segment 422b of power receiving element 422 may have a connection to diodes D₂, D₄ of the first diode rectifier 502 and to post opening 406c. FIG. 5 represents the OPEN position of band 404, as indicated by post 406a and post opening 406c being disengaged. It can be seen that in the OPEN position, the power receiving element 422 does not complete a circuit with the first diode rectifier 502. However, the first segments 422a, 424a of respective power receiving elements 422, 424 define a rectifier circuit comprising diodes D₅, D₁, D₇, D₃.

The first segment 424a of power receiving element 424 may have a connection to diodes D₅, D₇ of the second diode rectifier 504 and a connection to post 406a. The second segment 424b of power receiving element 424 may have a connection to diodes D₆, D₈ of the second diode rectifier 504 and to post opening 406c. It can be seen that in the OPEN position depicted in FIG. 5, the power receiving element 424 does not complete a circuit with the second diode rectifier 504. However, the second segments 422b, 424b of respective power receiving elements 422, 424 define a rectifier circuit comprising diodes D₆, D₂, D₈, D₄.

The terminals 408a, 408b, 408c, 408d may be any suitable electrical connection between respective segments 422a, 422b, 424a, 424b and circuitry 426. In some embodiments, the connection may occur on the band 404 (as illustrated in FIG. 5). In other embodiments (not shown), the connection may occur within the device body 402. In still other embodiments (not shown), the terminals 408a, 408b, 408c, 408d may comprise connectors in the band 404 that can engage with connectors in the device body 402. Still other means for electrical connections may be used, depending on the particular configuration of device body 402 and band 404.

FIG. 5A shows a CLOSED position of band 404. In the CLOSED position shown, the first and second segments 422a, 422b of power receiving element 422 are electrically connected (e.g., at node 442), and similarly the first and second segments 424a, 424b of power receiving element 424 are electrically connected (e.g., at node 442).

FIG. 5B highlights a circuit defined by the first power receiving element 422 and the first diode rectifier 502 when the band 404 is in a CLOSED position. FIG. 5C similarly highlights a circuit defined by the second power receiving element 422 and the second diode rectifier 504 when the band 404 is in the CLOSED position. The circuit defined by the first power receiving element 422 (e.g., highlighted in FIG. 5B) is connected in parallel with the circuit defined the second power receiving element 424 (e.g., highlighted in FIG. 5C) across capacitor C.

Referring to FIG. 6A, the electronic device 400 may receive power wirelessly via a charging platform 60. In some embodiments, for example, the charging platform 60 may comprise power transfer unit (PTU) 204 shown in FIG. 2. The charging platform 60 may generate an external magnetic field H (charging field) to provide power wirelessly to the electronic device 400. FIG. 6A shows the electronic device 400 in a first orientation relative to the externally generated magnetic field H. In particular, the figure shows the electronic device 400 with its side 432 closer to the charging platform 60 than side 434.

Referring to FIGS. 5A and 6A, in the CLOSED position shown in FIG. 5A, the first and second segments 422a, 422b of power receiving element 422 are connected together and the first and second segments 424a, 424b of power receiving element 424 are connected together. When power receiving elements 422, 424 are in the externally generated magnetic field H, they may (magnetically) couple to the externally generated magnetic field H and consequently a flow of current may be induced in the power receiving elements 422, 424. Since the first and second segments 422a, 422b of power receiving element 422 are connected together, current induced in the power receiving element 422 can produce a signal at terminals 408a, 408b that can be provided to the first diode rectifier 502 to produce a rectified output at V_{rect1}. Likewise, current induced in the power receiving element 424 can produce a signal at terminals 408c, 408d that can be provided to the second diode rectifier 504 to produce a rectified output at V_{rect2}.

Referring to FIG. 6A, in operation, the power receiving element 422 may couple more strongly to the externally generated magnetic field H than power receiving element 424, since power receiving element 422 is closer to the charging platform 60 and hence closer to the source of the externally generated magnetic field H. Accordingly, the voltage induced in power receiving element 422 may be greater than the voltage induced in power receiving element 424, and so current may flow in the circuit defined by power receiving element 422. With the voltage induced in power receiving element 422 being greater than the voltage induced in power receiving element 424, the diodes D₅-D₈ will become reverse biased and thus prevent current from flowing in the circuit defined by power receiving element 424.

The illustration in FIG. 5B may represent the difference in current flow in the respective circuits defined by power receiving element 422 and power receiving element 424 for the orientation shown in FIG. 6A. Since V_{rect}=V_{rect1}=V_{rect2}, the voltage at output V_{rect} may be determined by power receiving element 422 as the voltage generated by power receiving element 422 may be greater than that generated by power receiving element 424. Accordingly, diodes D₅, D₆ of the second diode rectifier 504 may become reverse biased, essentially “floating” the output of V_{rect2}. Consequently, there is virtually no flow of current in the second diode rectifier 504 (the second diode rectifier 504 may be deemed “inactive”), while there is current flow in the first diode rectifier 502 (the first diode rectifier 502 may be deemed “active”). The power at output V_{rect} will largely come from first diode rectifier 502.

FIG. 6B shows the electronic device 400 in another orientation relative to the externally generated magnetic field H. In particular, the figure shows the electronic device 400 with its side 434 closer to the charging platform 60 than side 432. In operation, the power receiving element 424 may couple more strongly to an externally generated magnetic field H than power receiving element 422 since power receiving element 424 is closer to the charging platform 60 and hence closer to the source of the externally generated magnetic field H. Accordingly, the voltage induced in power receiving element 424 may be greater than the voltage induced in power receiving element 422, and so current may flow in the circuit defined by power receiving element 424. With the voltage induced in power receiving element 422 being greater than the voltage induced in power receiving element 424, the diodes D₁-D₄ will become reverse biased and thus prevent current from flowing in the circuit defined by power receiving element 422.

The illustration in FIG. 5C may represent the difference in current flow in the circuit defined by power receiving element 422 and in the circuit defined by power receiving element 424 for the orientation shown in FIG. 6B. Since V_{rect}=V_{rect1}=V_{rect2}, the voltage at output V_{rect} may determined by 424 as it is greater than that generated by 422. Accordingly, diodes D₁, D₂ of the first diode rectifier 502 may become reverse biased, essentially “floating” the output of V_{rect1}. Consequently, there is virtually no flow of current in the first diode rectifier 502 (the first diode rectifier 502 may be deemed “inactive”), while there is current flow in the second diode rectifier 504 (the second diode rectifier 504 may be deemed “active”). The power at output V_{rect} will largely come from the second diode rectifier 504.

In some embodiments, the separation S (FIG. 4) between power receiving elements 422, 424 may be sufficiently small (e.g., in the case of a narrow band 404) so that the voltage difference at the outputs V_{rect1}, V_{rect2} (generated by 422, 424) may not be sufficient to cause reverse bias in either of the diode rectifiers 502, 504. In such an embodiment, the power at output V_{rect} may come from both diode rectifiers 502, 504.

FIG. 6C shows the electronic device 400 in two placement orientations with the band 404 in the OPEN position. In a first placement orientation (placement A), the first band segment 404a lies on the charging surface 60 and the second band segment 404b lies outside of the charging surface 60. In operation, first segments 422a, 424a (of respective power receiving elements 422, 424) in the first band segment 404a may couple to the externally generated magnetic field H. The illustration shown in FIG. 5D1 represents the circuit defined by first segments 422a, 424a, and highlights the induced current flow that can result in response to magnetically coupling to the externally generated magnetic field H. The circuit defined by first segments 422a, 424a may be a rectifier defined by diodes D₅, D₁, D₇, D₃.

FIG. 6C shows a second placement orientation (placement B), where the second band segment 404b lies on the charging surface 60 and the first band segment 404a lies outside of the charging surface 60. In operation, second segments 422b, 424b 424a (of respective power receiving elements 422, 424) in the second band segment 404b may couple to the externally generated magnetic field H. The illustration shown in FIG. 5D2 represents the circuit defined by second segments 422b, 424b, and highlights the induced current flow that can result in response to magnetically coupling with the externally generated magnetic field H. The circuit defined by second segments 422b, 424b may be a rectifier defined by diodes D₆, D₂, D₈, D₄.

Referring back to FIG. 4 for a moment, the first segments 422a, 424a (and likewise, second segments 422b, 424b) may not be arranged in parallel fashion as shown in FIG. 4. In some embodiments (not shown), for example, the first segments 422a, 424a may cross over somewhere between the post 406a and device body 402. Likewise, the second segments 422b, 424b may cross over somewhere between the post opening 406c and the device body 402. Such a cross-over configuration may help to equalize the field picked up when the band 404 is laying on its side (e.g., FIGS. 6A, 6B) on the charging surface (e.g., 60), or when the band 404 is in the OPEN position and laying on the charging surface (e.g., FIG. 6C). Alternatively, more complex routing of the first segments 422a, 424a and second segments 422b, 424b may also provide equalization of the field picked up in the different configurations.

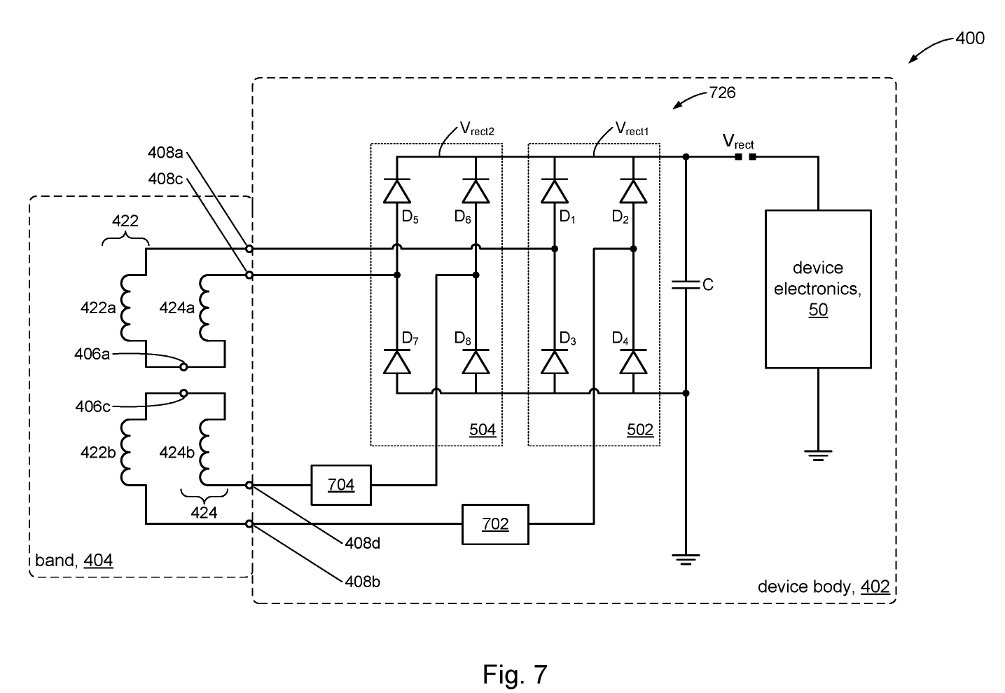

Referring to FIG. 7, in some embodiments, the electronic device 400 may include circuitry 726 comprising one or more tuning circuits 702, 704. The tuning circuits 702, 704 may comprise any suitable combination of reactive elements (e.g., inductor and/or capacitor) configured to define an operating frequency of respective power receiving elements 422, 424. In some embodiments, for example, tuning circuits 702, 704 may define a resonant frequency of respective power receiving elements 422, 424 that is equal to a resonant frequency of an externally generated magnetic field (e.g., H, FIG. 6A) in order to provide resonant wireless power transfer.

In some embodiments, the reactive elements comprising each tuning circuit 702, 704 may have selectable reactance values. A controller (not shown) may be configured to select suitable reactances for the tuning circuits 702, 704. The tuning circuits 702, 704 may be configured to have different reactance values in order to maintain a resonant frequency for when the band 404 is in the OPEN position and for when the band 404 is in the CLOSED position.

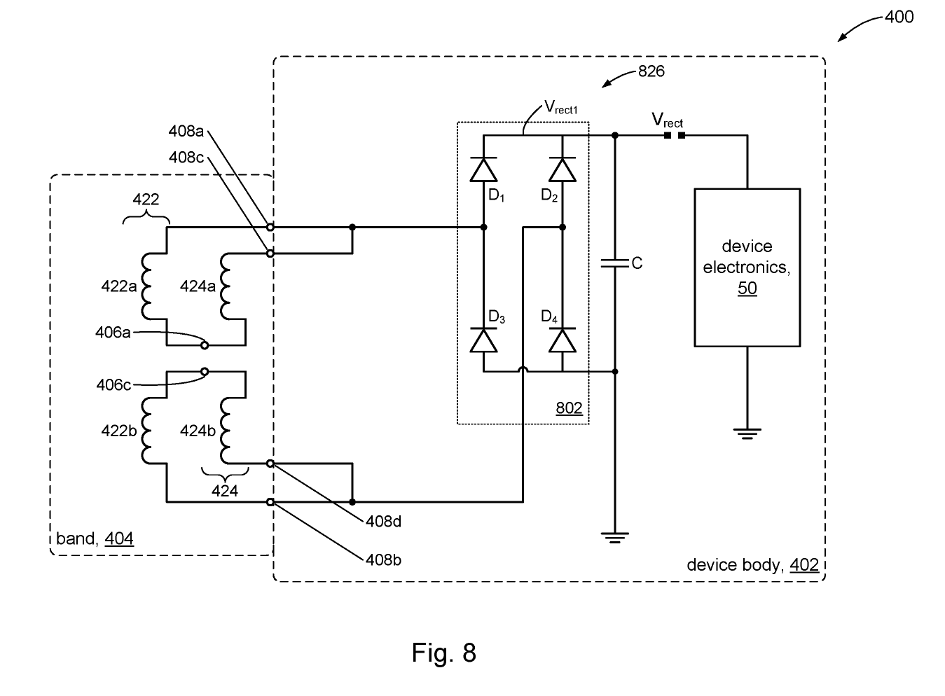

Referring to FIG. 8, in some embodiments, the electronic device 400 may include circuitry 826 comprising a single diode rectifier 802. The power receiving elements 422, 424 may be connected to the diode rectifier 802 in parallel. In some embodiments, the circuitry 826 may be suitable where the spacing s (FIG. 4) between power receiving elements 422, 424 is small (e.g., in the case of a narrow band 404). An externally generated magnetic field (e.g., H, FIG. 6A) may couple to the power receiving elements 422, 424 sufficiently equally so that neither power receiving element 422, 424 electrically loads the other. Stated differently, the induced voltage may be about the same in each power receiving element 422, 424.

In other embodiments, the circuitry 826 may be suitable where the electronic device 400 has only a single power receiving element (e.g., 422). A single power receiving element may be suitable if the band 404 is sufficiently narrow that the power receiving element may be arranged along a midline of the band 404 and have sufficient coupling to an externally generated magnetic field (e.g., H, FIG. 6A).

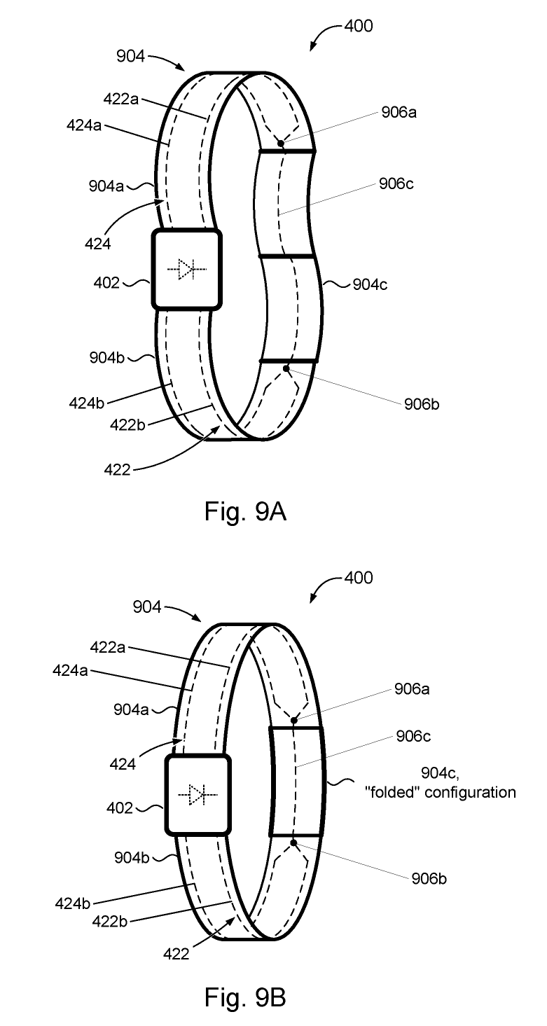

FIGS. 9A and 9B show a wearable device 400 having a fold-over kind of band 904. The band 904 may comprise a first band segment 904a, a second band segment 904b, and a folding mechanism 904c. FIG. 9A shows the band 904 in an OPEN position, while FIG. 9B shows the band in the CLOSED position.

The first segments 422a, 424a of respective power receiving elements 422, 424 may be arranged with the first band segment 904a. In some embodiments, the first segments 422a, 424a may be embedded within the material used to make the first band segment 904a. In other embodiments, the first segments 422a, 424a may arranged on or near the surface of the first band segment 904a. One end of the first segments 422a, 424a may connect to the device body 402, for example, at terminals 408a, 408c (FIG. 4). Another end of the first segments 422a, 424a may be electrically connected at a first node 906a.

Likewise, the second segments 422b, 424b of respective power receiving elements 422, 424 may be arranged with the second band segment 904b. In some embodiments, the second segments 422b, 424b may be embedded within the material used to make the second band segment 904b. In other embodiments, the second segments 422b, 424b may arranged on or near the surface of the second band segment 904b. One end of the second segments 422b, 424b may connect to the device body 402, for example, at terminals 408b, 408d (FIG. 4). Another end of the second segments 422b, 424b may be electrically connected at a second node 906b.

The first and second nodes 906a, 906b may be electrically connected by a connector 906c. In some embodiments the connector 906c may be an electrically conductive wire or trace that is arranged with and runs along the length of the folding mechanism 904c. In other embodiments, the folding mechanism 904c itself may be electrically conductive. The first and second nodes 906a, 906b may be electrically connected to respective ends of the electrically conductive folding mechanism 904c to electrically connect together the first and second nodes 906a, 906b. The connector 906c maintains an electrical connection between the first segments 422a, 424a of respective power receiving elements 422, 424 and their respective second segments 422b, 424b whether the band 904 is in an OPEN position (FIG. 9A) or in the CLOSED position (FIG. 9B). The electronic device 400 may be able to wirelessly receive power when the band 904 is in an OPEN position (FIG. 9A) or in the CLOSED position (FIG. 9B).

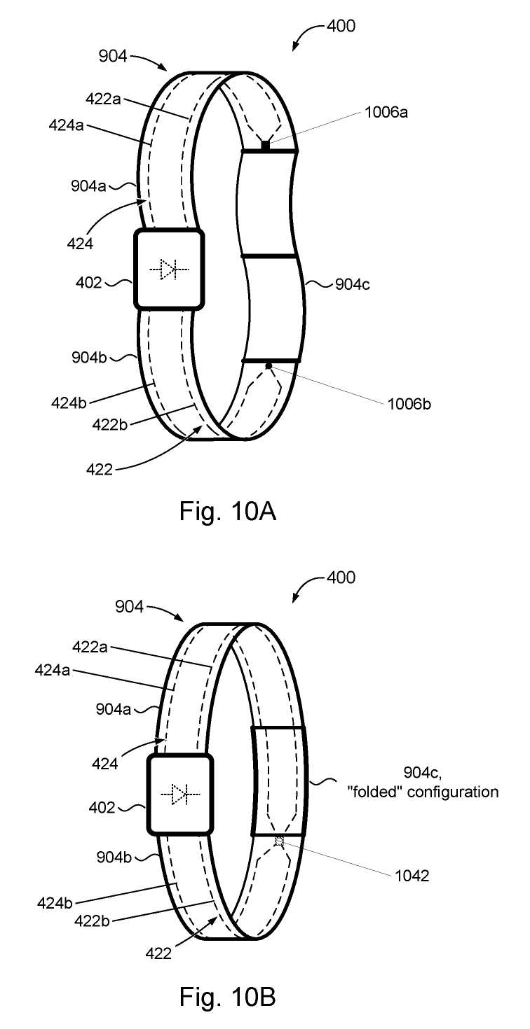

In some embodiments, the connector 906c shown in FIGS. 9A and 9B may be omitted. Referring to FIGS. 10A and 10B, in some embodiments, the first segments 422a, 424a of respective power receiving elements 422, 424 may be electrically connected at a first contact node 1006a, and second segments 422b, 424b of respective power receiving elements 422, 424 may be electrically connected at a second contact node 1006b. The nodes 1006a, 1006b can be positioned so as to electrically contact each other when the band 904 is in the CLOSED position to define node 1042, as shown in FIG. 10B. In the CLOSED position, the first segments 422a, 424a of respective power receiving elements 422, 424 may be electrically connected to their respective second segments 422b, 424b.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. An electronic device comprising:
a device body comprising electronic circuitry;
a band configured to secure the electronic device to a user, the band mechanically connected to the device body at a first location of the device body and at a second location of the device body;
a first power receiving element disposed at a first location of the band and having an electrical connection to the electronic circuitry at the first location of the device body and at the second location of the device body, the first power receiving element configured to magnetically couple to an externally generated magnetic field to wirelessly receive power; and
a second power receiving element disposed at a second location of the band and having an electrical connection to the electronic circuitry at the first location of the device body and at the second location of the device body, the second power receiving element configured to magnetically couple to the externally generated magnetic field to wirelessly receive power.

2. The electronic device of claim 1, wherein the first location of the band is along a first periphery of the band and the second location of the band is along a second periphery of the band.

3. The electronic device of claim 1, wherein the first power receiving element couples more strongly to the externally generated magnetic field than does the second power receiving element when the electronic device is in a first orientation relative to the externally generated magnetic field, wherein the second power receiving element couples more strongly to the externally generated magnetic field than does the first power receiving element when the electronic device is in a second orientation relative to the externally generated magnetic field.

4. The electronic device of claim 1, wherein the first and second power receiving elements have a common electrical connection at a location separate from the device body.

5. The electronic device of claim 1, wherein the first power receiving element comprises a first segment and a second segment, wherein the second power receiving element comprises a first segment and a second segment, the first segments of the first and second power receiving elements electrically connected together at a first node, the second segments of the first and second power receiving elements electrically connected together at a second node.

6. The electronic device of claim 5, further comprising an electrical connection between the first nodes and the second nodes.

7. The electronic device of claim 5, wherein the first and second nodes are electrically connected together when the band is in a closed position, wherein the first and second nodes are not electrically connected together when the band is in an open position.

8. The electronic device of claim 7, wherein the band comprises a first band segment having arranged therewith the first segments of the first and second power receiving elements, a second band segment having arranged therewith the second segments of the first and second power receiving elements, and an engagement mechanism configured to mechanically engage and disengage the first and second band segments.

9. The electronic device of claim 7, wherein the band is a fold-over kind of band comprising a first band segment having arranged therewith the first segments of the first and second power receiving elements, a second band segment having arranged therewith the second segments of the first and second power receiving elements, and a folding mechanism.

10. The electronic device of claim 1, wherein the first power receiving element is electrically connected to a first diode rectifier in the electronic circuitry and the second power receiving element is electrically connected to a second diode rectifier in the electronic circuitry.

11. The electronic device of claim 10, wherein the first diode rectifier is active and the second diode rectifier is inactive when the electronic device is in a first orientation relative to the externally generated magnetic field, wherein the first diode rectifier is inactive and the second diode rectifier is active when the electronic device is in a second orientation relative to the externally generated magnetic field.

12. The electronic device of claim 11, wherein one or more diodes that comprise the first diode rectifier are reverse biased when the first diode rectifier is inactive, wherein one or more diodes that comprise the second diode rectifier are reverse biased when the second diode rectifier is inactive.

13. The electronic device of claim 1, further comprising a plurality of diodes, wherein the first power receiving element is electrically connected to a first rectifier comprising a first subset of the plurality of diodes and the second power receiving element is electrically connected to a second rectifier comprising a second subset of the plurality of diodes when the band is in a closed position, wherein the first power receiving element is electrically connected to a third rectifier comprising a third subset of the plurality of diodes and the second power receiving element is electrically connected to a fourth rectifier comprising a fourth subset of the plurality of diodes when the band is in an open position.

14. The electronic device of claim 1, wherein the first power receiving element and the second power receiving element are electrically connected to a single diode rectifier in the electronic circuitry.

15. The electronic device of claim 1, wherein the first power receiving element is electrically connected to a first tuning circuit in the electronic circuitry to define a first resonant circuit, and the second power receiving element is electrically connected to a second tuning circuit in the electronic circuitry to define a second resonant circuit.

16. The electronic device of claim 15, wherein the first and second resonant circuits have respective resonant frequencies substantially equal to a frequency of the externally generated magnetic field.

17. The electronic device of claim 16, wherein the first and the second tuning circuits are electrically connected to respective first and second diode rectifiers in the electronic circuitry.

18. A method for an electronic wearable device comprising:
magnetically coupling to an externally generated magnetic field via a first power receiving element, incorporated with a band configured to secure the wearable device to a user, more strongly than to a second power receiving element incorporated with the band, when a first edge of the band is closer to a charging unit that produces the externally generated magnetic field than a second edge of the band;
magnetically coupling to the externally generated magnetic field via the second power receiving element more strongly than via the first power receiving element when the second edge of the band is closer to the charging unit than the first edge of the band; and
rectifying a first signal produced by the first power receiving element and a second signal produced by the second power receiving element to produce wirelessly received power for the wearable device.

19. The method of claim 18, wherein coupling to the externally generated magnetic field via the first or second power receiving element includes completing first and second circuits defined respectively by the first and second power receiving elements and rectifying the first and second signals produced by the first and second power receiving elements via the first and second circuits.

20. The method of claim 19, wherein the first and second circuits are completed when the band is in a closed position.

21. The method of claim 18, wherein the rectifying includes generating a first rectified signal and a second rectified signal and combining the first and second rectified signals to produce power for the wearable device.

22. The method of claim 21, further comprising using a first diode circuit to generate the first rectified signal and using a second diode circuit to generate the second rectified signal.

23. The method of claim 18, wherein the rectifying includes combining the first second signals respectively from the first and second power receiving elements and generating a rectified signal from the combined first and second signals.

24. The method of claim 18, further comprising operating the first power receiving element at a frequency substantially equal to a frequency of the externally generated magnetic field and operating the second power receiving element at a frequency substantially equal to the frequency of the externally generated magnetic field.

25. An electronic device comprising:
means for securing the electronic device to a user of the electronic device;
first means for magnetically coupling to an externally generated magnetic field to wirelessly receive power, the first means disposed at a first location of the means for securing; and
second means for magnetically coupling to an externally generated magnetic field to wirelessly receive power, the second means disposed at a second location of the means for securing spaced apart from the first location of the means for securing.

26. The electronic device of claim 25, further comprising means for rectifying signals produced by the first means and by the second means.

27. The electronic device of claim 26, wherein the means for rectifying comprises a single diode rectifier circuit.

28. The electronic device of claim 26, wherein the means for rectifying comprises a first diode rectifier electrically connected to the first means and a second diode rectifier electrically connected to the second means.
